(19) United States
(12) Patent Application Publication
(10) Pub. No.: US 2015/0329255 A1
(43) Pub. Date: Nov. 19, 2015

(54) Jar Lid Including an Accessory

(71) Applicant: Mason Jars Company, Wattsburg, PA (US)

(72) Inventor: Karen Rzepecki, Wattsburg, PA (US)

(73) Assignee: Mason Jars Company, Wattsburg, PA (US)

(21) Appl. No.: 14/687,413

(22) Filed: Apr. 15, 2015

Related U.S. Application Data
(60) Provisional application No. 61/993,777, filed on May 15, 2014.

(51) Int. Cl. B65D 51/24; B65D 43/02; B65D 47/06; G02B 25/00; B65D 43/16; B65D 41/04; A47G 21/18; B65D 25/28; B65D 51/28

(52) U.S. Cl. CPC B65D 51/24; B65D 25/28; B65D 43/0225; B65D 47/06; B65D 51/28; B65D 43/16; B65D 41/0407; A47G 21/18; G02B 25/002; B65D 2525/283; B65D 2543/00277; B65D 2543/00296; B65D 2543/00268; B65D 2543/00305; B65D 2251/0021; B65D 2251/0081

(57) ABSTRACT

What is presented is a jar lid for releasably securing to a jar. The jar lid comprises an opening that goes through the jar lid, a lid base that extends from the jar lid, and a mounting instrument that is for permitting an accessory to be releasably mounted to the jar lid. The lid base is for releasably securing the jar lid to the mouth of the jar. The jar lid could be made from polymer-plastic material, metallic material, acrylic-based material, wood, cloth, glass, or paper-based material.

### BACKGROUND

In the past, to close off the mouth of a jar, a closure would typically be applied to the mouth. These closures can be problematic because they merely seal the jar and provide no ability to make pouring the contents. An improved jar lid is presented that not only keeps the contents within the jar unexposed to the surrounding environment, but also allows for easy and simple access to these contents as well as facilitates their dispensing.

It has also been discovered that additional components can be added to these jar lids to expand and transform their capabilities. These capabilities can transform the jar lid from simply a more-convenient covering device to something even more desirable and marketable. The improvements presented herein expand and transform the capabilities of the jar lid as well as help make it more desirable and marketable.

### SUMMARY

What is presented is a jar lid for releasably securing to a jar. The jar lid comprises an opening that goes through the jar lid, a lid base that extends from the jar lid, and a mounting instrument that is for permitting an accessory to be releasably mounted to the jar lid. The lid base is for releasably securing the jar lid to the mouth of the jar. The jar lid could be made from polymer-plastic material, metallic material, acrylic-based material, wood, cloth, glass, or paper-based material.

In some embodiments, the jar lid comprises a plug that is hingedly secured to the jar lid. The plug being for releasably plugging the opening. In other embodiments, the jar lid comprises a flip-top cap that is hingedly secured to the jar lid. The flip-top cap being for releasably covering the opening. In other embodiments, the opening of the jar lid comprises a spout. In other embodiments, the opening of the jar lid comprises an extended spout with spout threading.

The jar lid could comprise a handle and/or a gasket. The gasket would be secured to the underside of the jar lid. The gasket is for creating a seal between the jar lid and the mouth of the jar, when the jar lid is releasably secured to the mouth of the jar. The jar lid could comprise an inner rim on its underside with the mounting instrument being at this inner rim. The mounting instrument could also be for permitting the accessory to be releasably mountable to the opening of the jar lid. The mounting instrument could possibly be a clip, tack, screw, friction fitting, or threading.

The lid base could peripherally extend from the jar lid and it could also comprise threading. The lid base could also be connectable to the jar lid and not permanently connected. The accessory could possibly be a magnifying lens, container, fluid pourer, strainer, portion cup, straw, fluid pump, counter ring, or infuser.

What is also presented is a jar lid for releasably securing to a jar. This jar lid comprises an opening that goes through the jar lid, a lid base that extends from the jar lid, a mounting instrument that is for permitting an accessory to be releasably mounted to the jar lid, and a gasket that is secured to the underside of the jar lid. The opening comprises an extended spout with spout threading. The lid base is for releasably securing the jar lid to the mouth of the jar and comprises threading for threadably securing the jar lid to the mouth of the jar. The gasket creates a seal between the jar lid and the mouth of the jar, when the jar lid is threadably secured to the mouth of the jar. The jar lid could be made from polymer-plastic material, metallic material, acrylic-based material, wood, cloth, glass, or paper-based material.

The jar lid could comprise a handle and the opening could be centrally located on the body of the jar lid. The jar lid could comprise an inner rim on its underside and the mounting instrument being at this inner rim. The mounting instrument could also be for permitting the accessory to be releasably mounted to the opening of the jar lid. The mounting instrument could possibly be a clip, tack, screw, friction fitting, or threading. The accessory could possibly be a magnifying lens, container, fluid pourer, strainer, portion cup, straw, fluid pump, counter ring, or infuser.

What is also presented is a jar lid for releasably securing to a jar. This jar lid comprises an opening that goes through the jar lid, a lid base that extends from the jar lid, a mounting instrument that is for permitting an accessory to be releasably mounted to the jar lid, a hingedly secured plug, and a gasket that is secured to the underside of the jar lid. The opening comprises a spout. The plug is for releasably plugging the opening. The lid base is for releasably securing the jar lid to the mouth of the jar and comprises threading for threadably securing the jar lid to the mouth of the jar. The gasket creates a seal between the jar lid and the mouth of the jar, when the jar lid is threadably secured to the mouth of the jar. The jar lid could be made from polymer-plastic material, metallic material, acrylic-based material, wood, cloth, glass, or paper-based material.

The jar lid could comprise a handle. The jar lid could also comprise an inner rim on its underside and the mounting instrument being at this inner rim. The mounting instrument could also be for permitting the accessory to be releasably mounted to the opening of the jar lid. The mounting instrument could possibly be a clip, tack, screw, friction fitting, or threading. The accessory could possibly be a magnifying lens, container, fluid pourer, strainer, portion cup, straw, fluid pump, counter ring, or infuser.

What is also presented is a jar lid for releasably securing to a jar. This jar lid comprises an opening that goes through the jar lid, a lid base that extends from the jar lid, a mounting instrument that is for permitting an accessory to be releasably mounted to the jar lid, a hingedly secured flip-top cap, and a gasket that is secured to the underside of the jar lid. The opening comprises a spout. The flip-top cap is for releasably covering the opening. The lid base is for releasably securing the jar lid to the mouth of the jar and comprises threading for threadably securing the jar lid to the mouth of the jar. The gasket creates a seal between the jar lid and the mouth of the jar, when the jar lid is threadably secured to the mouth of the jar. The jar lid could be made from polymer-plastic material, metallic material, acrylic-based material, wood, cloth, glass, or paper-based material.

The jar lid could comprise a handle. The jar lid could also comprise an inner rim on its underside and the mounting instrument being at this inner rim. The mounting instrument could also be for permitting the accessory to be releasably mounted to the opening of the jar lid. The mounting instrument could possibly be a clip, tack, screw, friction fitting, or threading. The accessory could possibly be a magnifying lens, container, fluid pourer, strainer, portion cup, straw, fluid pump, counter ring, or infuser.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows a perspective view of a jar lid releasably secured to a jar;

FIG. 2 shows a perspective view of the jar lid, with the plug in the open position and an opening being exposed;

FIG. 3 shows a front-side view of the jar lid of FIG. 2 with the plug in the closed position;

FIG. 4 shows a side view of the jar lid of FIG. 2;

FIG. 5 shows a back-side view of the jar lid of FIG. 2;

FIG. 6 shows a side view of the jar lid of FIG. 2 with the plug in the open position;

FIG. 7 shows a perspective view of the underside of the jar lid of FIG. 2 with an accessory releasably mounted to the inner rim of the jar lid;

FIG. 8 shows a perspective view of the jar lid of FIG. 2 with the accessory dismounted from the jar lid;

FIG. 9 shows a perspective view of another embodiment of the jar lid with a different embodiment of an accessory dismounted from the jar lid;

FIG. 10 shows a cut-away side view of the jar lid of FIG. 9 with the accessory of FIG. 9 releasably mounted to the inner rim of the jar lid;

FIG. 11 shows a bottom view of another embodiment of the jar lid with a different embodiment of an accessory releasably mounted to the inner rim of the jar lid;

FIG. 12 shows a perspective view of the jar lid of FIG. 11 with the accessory of FIG. 11 dismounted from the jar lid;

FIG. 13 shows a perspective view of another embodiment of the jar lid with the plug in the open position, exposing the opening, and another embodiment of the accessory dismounted from the jar lid;

FIG. 14 shows a cut-away side view of the jar lid of FIG. 13, with the plug in an open position, and depicting the accessory of FIG. 13 being releasably mounted to the inner rim of the jar lid through a friction fitting;

FIG. 15 shows a perspective view of another embodiment of the jar lid, with the plug in an open position, and with another embodiment of the accessory releasably mounted to the opening of the jar lid;

FIG. 16 shows a cut-away side view of another embodiment of the jar lid releasably secured to a jar, with a different embodiment of the accessory releasably mounted to the inner rim of the jar lid;

FIG. 17 shows a cut-away side view of another embodiment of the jar lid, with the plug in an open position, and the inner rim of the jar lid comprising threading;

FIG. 18 shows a cut-away side view of another embodiment of the jar lid, with the plug in an open position, and the inner rim of the jar lid comprising clips;

FIG. 19 shows a perspective view of another embodiment of the jar lid with a different embodiment of an accessory releasably mounted to the lid base of the jar lid;

FIG. 20 shows a perspective view of another embodiment of the jar lid that does not comprise a plug and with the opening exposed;

FIG. 21 shows a perspective view of the jar lid of FIG. 19, comprising the plug releasably plugging the opening of the jar lid;

FIG. 22 shows a perspective view of another embodiment of the jar lid with another embodiment of the accessory releasably mounted to the inner rim of the jar lid;

FIG. 23 shows a perspective view of another embodiment of the jar lid with another embodiment of the accessory releasably mounted to the opening of the jar lid;

FIG. 24 shows a cut-away side view of the jar lid of FIG. 23 with the accessory of FIG. 23 releasably mounted to the opening of the jar lid;

FIG. 25 shows a perspective view of another embodiment of the jar lid with the accessory of FIG. 8 dismounted from the opening of the jar lid;

FIG. 26 shows a perspective view of another embodiment of the jar lid with a flip-top cap that is in the open position to expose the opening of the jar lid;

FIG. 27 shows a perspective view of the jar lid of FIG. 26 with the flip-top cap in the closed position;

FIG. 28 shows a perspective view of another embodiment of the jar lid with the flip-top cap in the open position and another embodiment of the accessory releasably mounted to the flip-top cap;

FIG. 29 shows a perspective view of another embodiment of the jar lid releasably secured to ajar; and

FIG. 30 shows a side view of the jar lid of FIG. 29.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

A jar is a cylindrical containment device with a mouth at one end. Jars are typically made from glass, ceramic, or plastic. Jars can be used to store contents such as foods, cosmetics, mechanical devices, medications, chemicals, or anything too large to be removed from the narrow neck of a bottle. Jars can also be used to preserve more-perishable contents such as salad dressings, jams, parmesan cheese, pickles, marmalades, eggs, meats, olives, sugar, fish, honey, smoothies and other various liquids.

Mason jars are a type of jar that is widely used and distributed in the marketplace. The term “Mason” is still the common term for the jar but they are also referred to as Ball jars, fruit jars or canning jars. Mason jars have a standard continuous thread in two standard mouth sizes—a regular mouth and wide mouth. This is the common definition of mason jars, however, any screw-neck jar can be considered a “mason jar.” In fact, you can find jars that have “Mason” embossed on them that are neither the standard sizes nor have a screw thread. Jars come in a variety of volumes for both mouth sizes, as small as 4 ounces or as large as a gallon—sometimes they can be more.

In the past, to close off the mouth of the jar a closure, such as, a screw cap, lug cap, cork stopper, would typically be applied to the mouth of the jar. These closures are used to create a seal at the mouth of the jar so that the contents within the jar can be stored and/or preserved. However, such closures only seal the jar but do not assist in dispensing the contents of the jar. For example, pouring salad dressing from the jar and onto a salad has proven to be a difficult task because the salad dressing tends to spill out of the jar to cause a mess. Moreover, these closures also take considerable effort and energy to remove from the mouth of the jar. In many instances, a user would need some type of gripping devices to assist their effort in the removal of the closure, which can be a time consuming, stressful, and frustrating effort. Thus, there was a desire to create a jar lid that made pouring the contents of the jar easier, less messy, and more accessible.

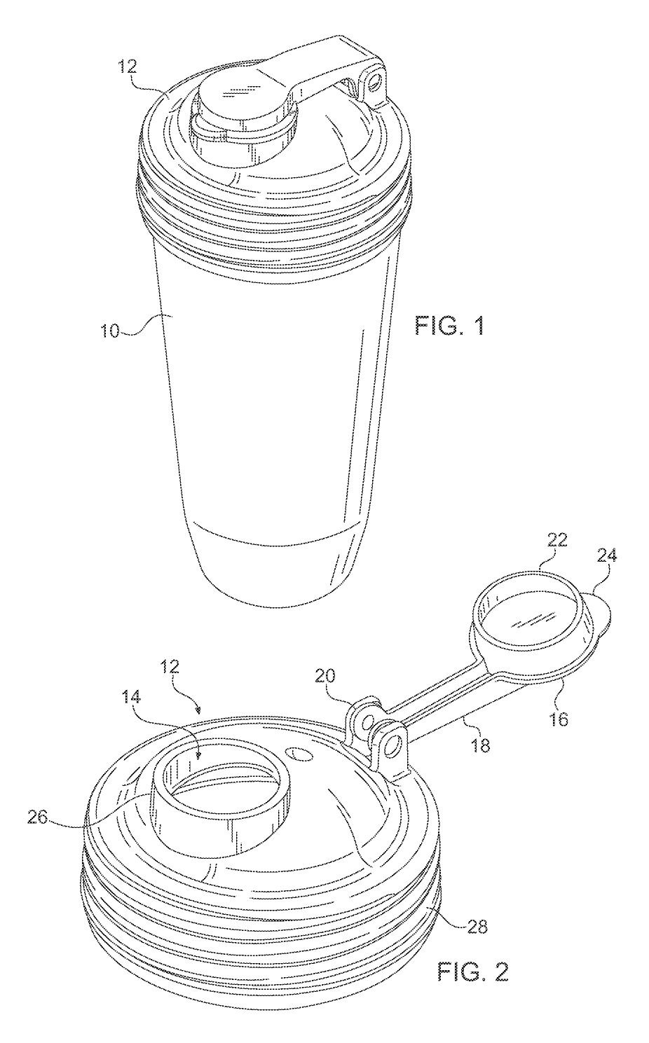

FIG. 1 shows a jar 10 onto which a releasably securable jar lid 12 is secured. These jar lids 12 have been found to be a very practical solution to some of the limitations of previous closures. They not only keep the contents within the jar 12 fresh and unexposed to the surrounding environment, but they also allow easier and simple access to the contents (not shown) within the jar 10. These jar lids 12 are also effective at dispensing such contents. The jar lid 12 releasably secures to the jar 10 by screwing onto the mouth of the jar 10 with threads, discussed in more detail below. Many embodiments of the securable jar lid 12 are sized to fit regular mouth or wide mouth mason jars. These jar lids 12 are typically made from polymer-plastic material. However, it should be understood that the jar lids 12 could be made from other materials, such as, but not limited to, metals, acrylics, wood, cloth, glass, or paper-based material. These jar lids 12 may also be sized to fit any type of jar 10 and should not be limited to regular mouth or wide mouth mason jars.

As shown in FIG. 2, this embodiment of the jar lid 12 has a semi dome-shaped body and includes an opening 14 that goes directly through the jar lid 12. A plug 16 that is hingedly secured to the jar lid 12 via a plug lever 18 and hinge 20 and can releasably plug the opening 14. The plug 16 includes a plug seal 22 and a plug tab 24. When the opening 14 is plugged, the plug seal 22 completely blocks the opening 14 and prevents leakage into and out of the jar 10. The plug tab 24 assists in releasing the plug 16 from the opening 14. In this embodiment, the opening 14 includes a spout 26 that facilitates the dispensing of contents from the jar, by helping to direct the contents after passing through the opening 14. It should be understood that the opening 14 could include cross sections that are not circular, as shown, such as, but not limited to, square, octagonal, triangular, or some other appropriate shape.

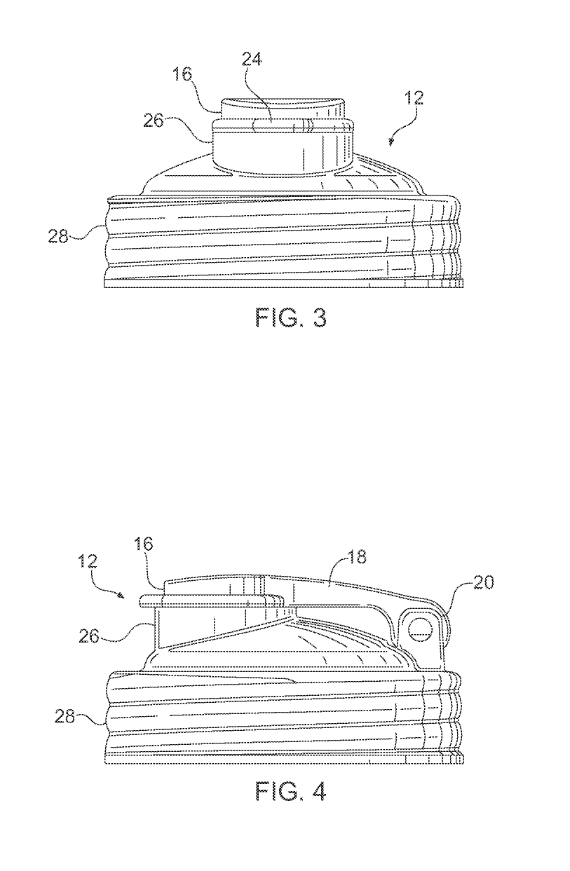

As best shown in FIGS. 3 and 4, the jar lid 12 also includes a lid base 28 that allows the jar lid 12 to releasably secure to the mouth of the jar. In this embodiment, the lid base 28 is ribbed on both its outer surface and inner surface. The ribbing on the inner surface of the jar lid 12 corresponds with the threading surrounding the mouth of the respective jar, which allows the jar lid 12 to releasably secure to the jar. The ribbing on the outer surface of the jar lid 12 provides grip on the lid base 28 that facilitates releasing and/or securing the jar lid 12 to and from the jar. The ribbing also gives the outer surface of the jar lid 12 a distinctive look and feel. However, it should be understood that the lid base 28 does not need to include ribbing and can include a variety of other surface orientations, such as, but not limited to, vertically-oriented gripping bumps. It should be also understood that the lid base 28 could be its own independent ring-shaped component peripherally connectable to the jar lid 12 and not necessarily permanently connected the body of the jar lid 12.

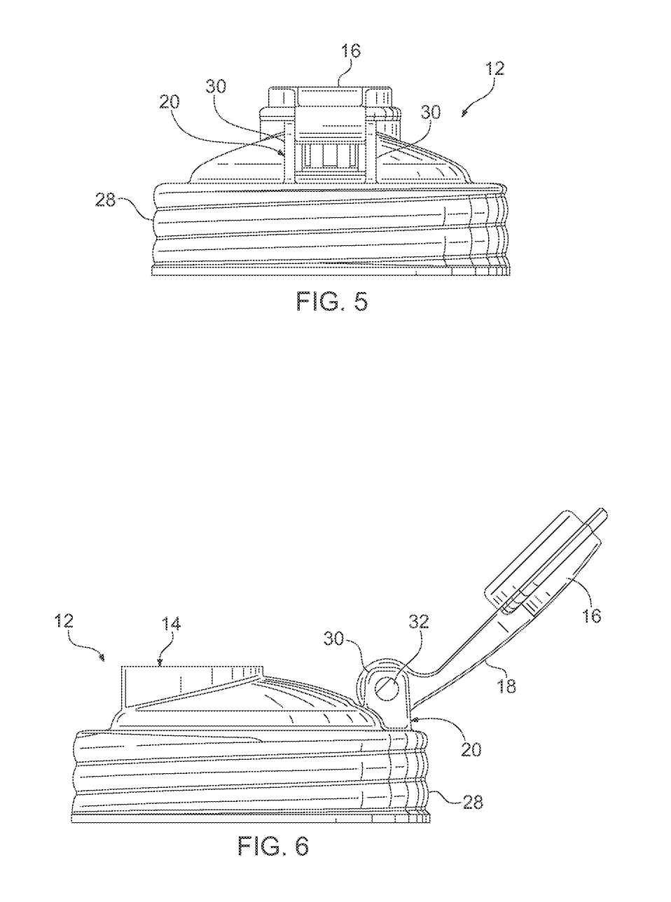

As best shown in FIGS. 5 and 6, in this embodiment, the hinge 20 is similar to a barrel hinge. The hinge 20 includes a plurality of hinge tabs 30, each having a hinge hole 32 and located on the jar lid 12. The plug lever 18 includes a plurality of substantially-round lever prongs (not shown) that insert into the hinge holes 32 to create an axle. This axle is a pivot point for both the plug lever 18 and the plug 16 to rotate around. It should be understood that other embodiments of the hinge 20 can work, so long as the hinge 20 provides a connection between both the jar lid 12 and the plug 16 and allows the plug 16 to rotate relative to the jar lid 12 about a fixed axis of rotation. Examples of other embodiments of the hinge 20 include, but are not limited to, a living hinge, butt hinge, and strap hinge.

Since the inception of the jar lid 12, it was discovered that the incorporation of accessories, not typically thought to be associated with jars or any corresponding lids, can improve certain aspects of the jar lid 12. In some instances, the incorporation of accessories has been found to enable the jar lid 12 to work in conjunction with the jar in various unique ways. These accessories provide capabilities not found in the jar lid 12 alone and may even permit the jar to become more than a containment device. To allow these accessories to be incorporated into the jar lid 12, the jar lid 12 is constructed to incorporate a mounting instrument, discussed below, that will permit an accessory to be releasably mountable to it.

With these new capabilities, the jar lids 12 are able to appeal to a variety of consumers that would not be interested in the jar lid 12 by itself, which opens up opportunities and allows the jar lid 12 to be sold in a variety of new markets. Thus, it is believed the improved jar lids 12 can create commercial success that goes beyond the commercial success found in the original jar lid 12.

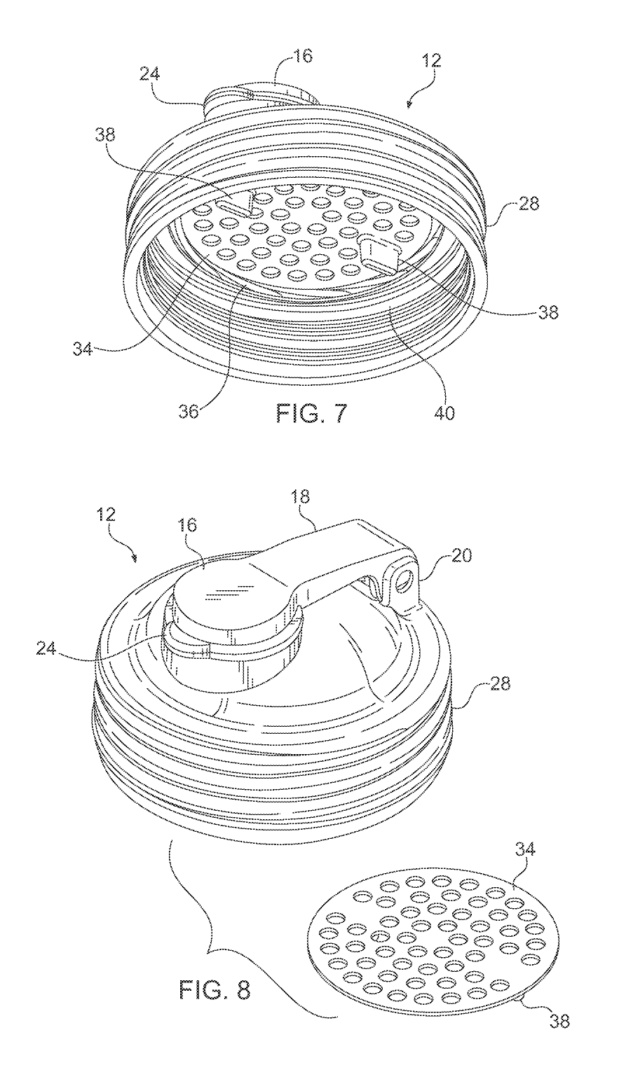

As shown in FIGS. 7 and 8, the accessory 34 can be a strainer. This strainer embodiment of the accessory 34 can facilitate even distribution of powder-like substances being poured out of the opening. For example, fine grains of flour, sugar, or parmesan cheese can be poured out without any large-condensed clumps being able to escape through the opening. This strainer embodiment of the accessory 34 can also filter contents that are fluid in nature. For example, the jar 12 may contain teas, juices or other liquids that include fruit for additional flavoring purposes. These teas, juices, or other liquids can now be freely poured out with much less chance that any of the fruits being able to escape out through the opening. It should be understood that the strainer embodiment of the accessory 34 can be used for other filtering/distributing purposes not discussed herein. It should also be understood that this embodiment of the accessory 34 could also be considered as a sieve, sifter, or colander.

This embodiment of the jar lid 12 includes an inner rim 36 on its underside. The accessory 34 is releasably mounted to the inner rim 36 through the mounting instrument, which in this embodiment is the friction fitting between the accessory 34 and the inner rim 36. Once mounted to the inner rim 36, the friction fitting helps to keep the accessory 34 in place and from accidentally dismounting from the jar lid 12. The strainer embodiment of the accessory 34 includes a plurality of strainer tabs 38 that make dismounting the accessory 34 easier. A user (not shown) can grip at least one of the strainer tabs 38 and separate the accessory 34 from the jar lid 12 by twisting or pulling one apart from the other.

In certain instances, the strainer embodiment of the accessory 34 includes a plurality of strainer clips (not shown) that allow additional accessories to releasably mount to the accessory 34. These additional accessories could be embodied as an infuser and/or container, discussed below, or something else. Allowing additional accessories to releasably mount to the accessory 34 further improves certain aspects of the accessory 34 and/or the capabilities of the accessory 34, jar, and/or jar lid 12.

The jar lid 12 also includes a gasket 40 that is secured to its underside. The gasket 40 assists by helping to create a seal between the jar lid 12 and the mouth of the jar (not shown) when the jar lid 12 is releasably secured to the mouth of the jar. When used in the ideal manner, this seal keeps the contents within the jar from escaping anywhere other than the opening of the jar lid 12. It should be understood that devices other than a gasket 40 can be incorporated on the underside of the jar lid 12, so long as they assist by helping to create a seal between the jar lid 12 and the mouth of the jar, when the jar lid 12 is releasably secured to the mouth of the jar.

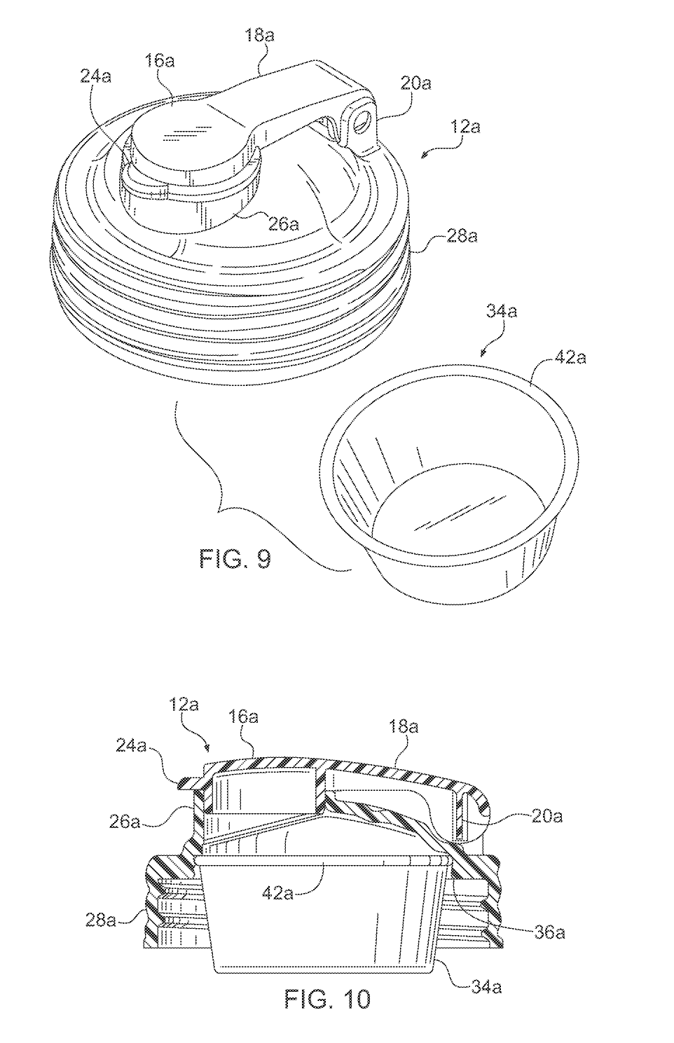

As shown in FIGS. 9 and 10, the accessory 34a can be a portion cup. This portion cup embodiment of the accessory 34a works in conjunction with the jar. When the jar lid 12a is secured to the jar, the accessory 34a takes advantage of any unneeded empty space within the jar. This allows the accessory 34a to contain its own set of contents that are segregated from the contents within the jar. For example, if the jar contains some variety of yogurt, the accessory 34a may contain a topping for the yogurt, such as, but not limited to, granola, fruit, vegetables, syrup, or some variety of candy. A user (not shown) may release the jar lid 12a from the jar, dismount the accessory 34a from the jar lid 12a, and then empty the contents from the accessory 34a into the yogurt within the jar. The user could also empty the contents from the accessory 34a and empty the yogurt from within the jar in the same location, or separate locations, for mixing purposes. It should be understood the above is only one example of the implementation of this embodiment of the accessory 34a. The portion cup embodiment of the accessory 34a can be used for other containment/segregation purposes not discussed herein.

This embodiment of the jar lid 12a includes an inner rim 36a on its underside. The portion cup embodiment of the accessory 34a is releasably mounted to the inner rim 36a through the mounting instrument, which in this embodiment is the friction fitting between the accessory 34a and the inner rim 36a. A lip 42a around a portion of the perimeter of the accessory 34a is able to make contact with the inner rim 36a. Once mounted to the inner rim 36a, the friction fitting between the lip 42a and the inner rim 36a helps to keep the accessory 34a in place and from accidentally falling off the jar lid 12a.

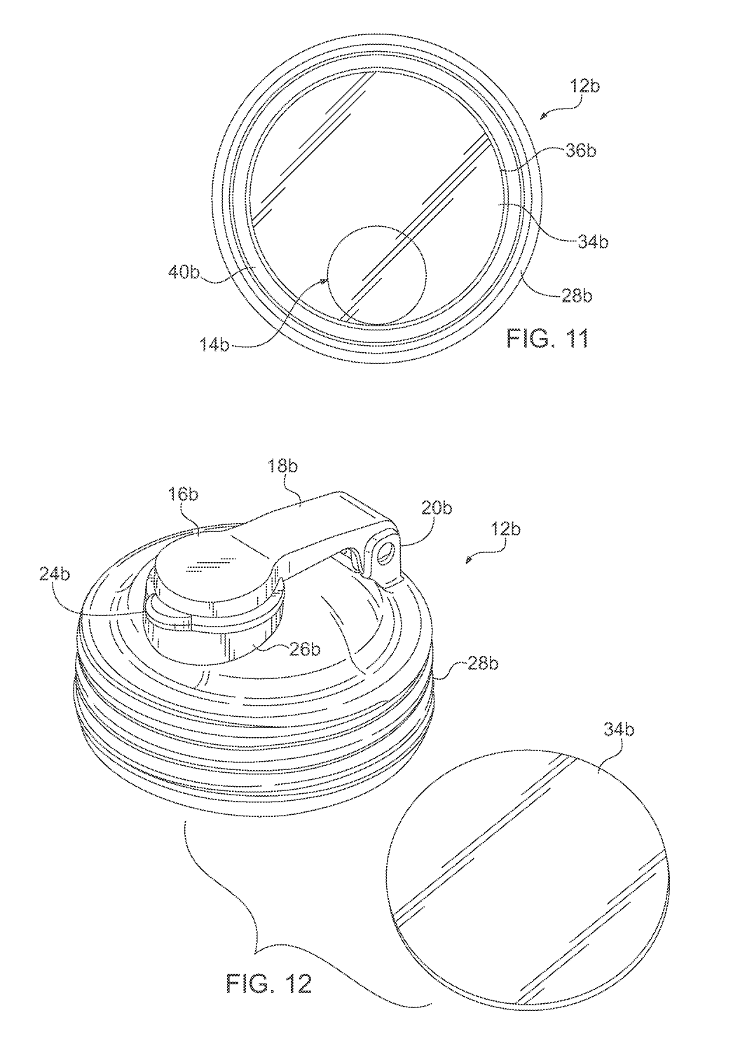

As shown in FIGS. 11 and 12, the accessory 34b can be a magnifying lens. This magnifying lens embodiment of the accessory 34b works in conjunction with the jar. The accessory 34b takes advantage of the jar when containing contents that can be viewed in better detail through magnification by the accessory 34b. For example, if the jar contains some insect or small object that is hard to discern through normal viewing, a user (not shown) can better understand the details of the insect or object by viewing it through the accessory 34b. The user may then release the jar lid 12b from the jar, remove the insect or object from within the jar, and replace the insect or object with some other item to be viewed. It should be understood the above is only a couple of examples of the implementation of this embodiment of the accessory 34b. The magnifying lens embodiment of the accessory 34b can be used for other purposes not discussed herein. It should also be noted that the opening 14b of the jar lid 12b can be used as an eye hole to view the contents within the jar. As shown, the opening 14b is seen directly through the accessory 34b to provide a better understanding of this concept.

This embodiment of the jar lid 12b includes an inner rim 36b on its underside. The magnifying lens embodiment of the accessory 34b is releasably mounted to the inner rim 36b through the mounting instrument, which in this embodiment is the friction fitting between the accessory 34b and the inner rim 36b. Once mounted to the inner rim 36b, the friction fitting helps to keep the accessory 34b in place and from accidentally falling off the jar lid 12b. It should be noted that the gasket 40b of the jar lid 12b can be best understood through FIG. 11.

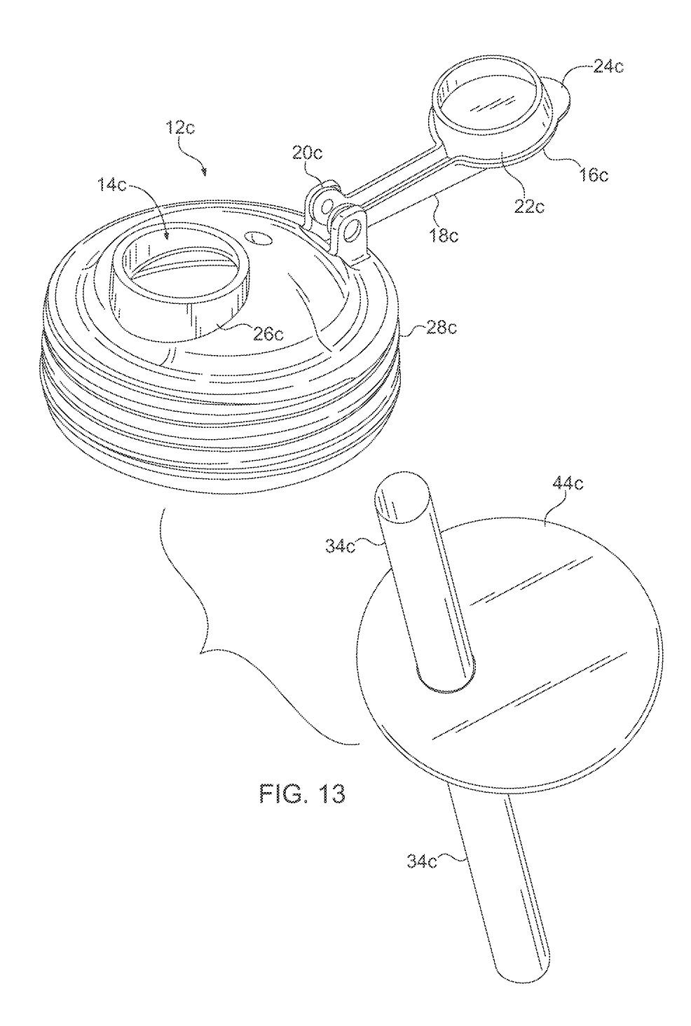

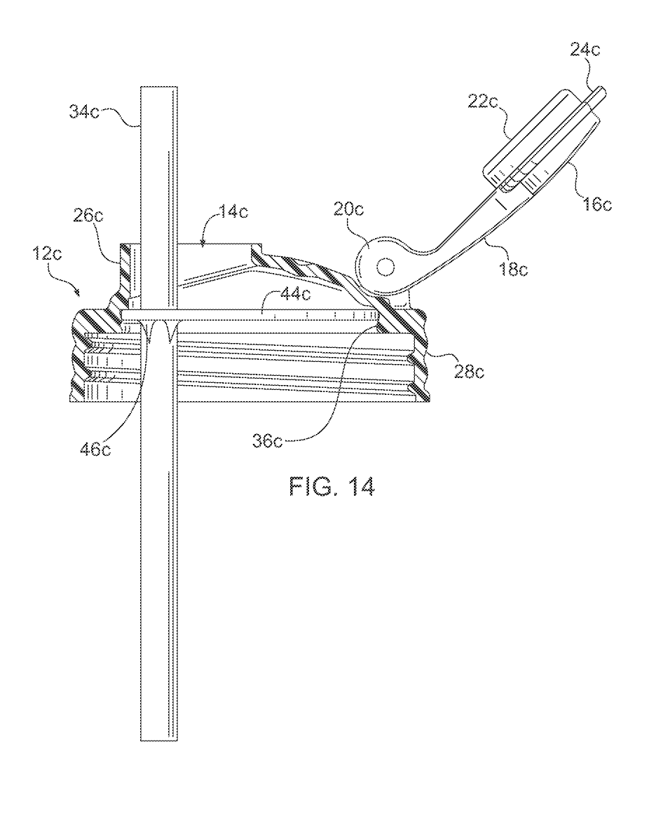

As shown in FIGS. 13 and 14, the accessory 34c can be a straw. This straw embodiment of the accessory 34c improves the jar lid 12c by allowing a user (not shown) to take a drink from the jar without having to pour the contents into their mouth or onto some other location. For example, a user may fill the jar with a drinkable liquid such as, juice, water, or milk and then take a drink without needing to tip the jar. This can reduce the risk of creating a mess when the user is not being very careful. It should be understood the above is only one example of the implementation of this embodiment of the accessory 34c and there may be other implementations not discussed herein. As shown, the accessory 34c has a tubular shape, but the accessory 34c can have some other shape, so long as the shape allows a user to drink from the jar without having to pour the contents from within the jar into their mouth or some other location.

The straw embodiment of the accessory 34c includes a straw adaptor 44c and this embodiment of the jar lid 12c includes an inner rim 36c on its underside. The straw adaptor 44c is releasably mounted to the inner rim 36c through the mounting instrument, which in this embodiment is the friction fitting between the straw adaptor 44c and the inner rim 36b. Once mounted to the inner rim 36b, the friction fitting helps to maintain the proper position of the straw adaptor 44c and from accidentally falling off the jar lid 12b. The accessory 34c slidably mounts to the straw adaptor 44c through an adaptor hole (not shown) that has a plurality of adaptor teeth 46c. The adaptor teeth 46c maintain both the proper position of the accessory 34c as well as its orientation.

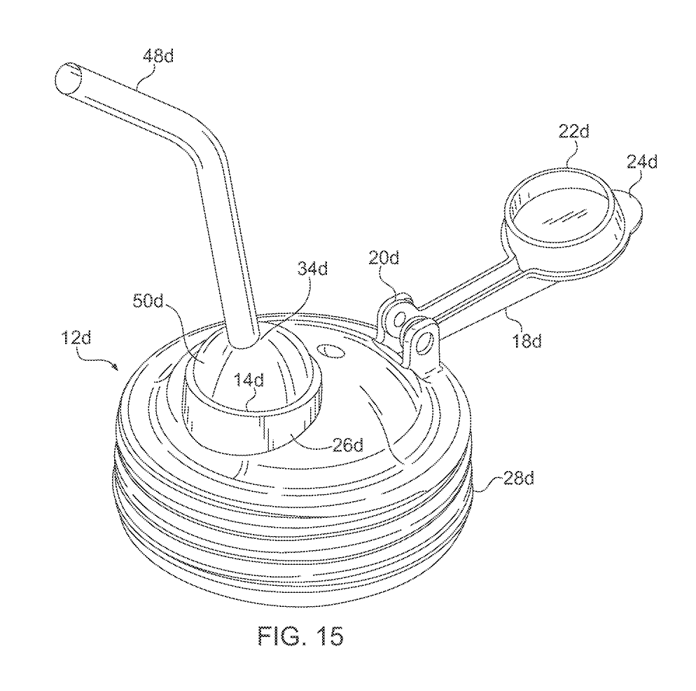

As shown in FIG. 15, the accessory 34d can be a fluid pourer, which is sometimes referred to as a “pour spout” or “liquor spout.” The accessory 34d allows a user (not shown) to maintain pouring and measuring control when dispensing certain fluids from the jar and through the opening 14d. For example, if the jar contains some variety of liquor, the liquor may be easily dispensed into a cup, at a certain measurement, with a reduced chance of loss through unwanted spillage. It should be understood the above is only one example of the implementation of this embodiment of the accessory 34d and there may be other implementations not discussed herein.

The fluid pourer embodiment of the accessory 34d includes a pouring tube 48d and a pouring plug 50d. The pouring tube 48d guides and controls the amount of the fluids being dispensed and is the only location through which fluids can escape out the opening 14d. The accessory 34d is releasably mounted to the opening through the mounting instrument, which in this embodiment is the friction fitting between the pouring plug 50d and the opening 14d. Once mounted to the opening 14d, the friction fitting between the pouring plug 50d and the opening 14d helps to keep the accessory 34d in place and from accidentally falling off the jar lid 12d. This friction fitting also helps to create a seal that ideally keeps fluids from escaping anywhere through the opening 14d, except out of the pouring tube 48d.

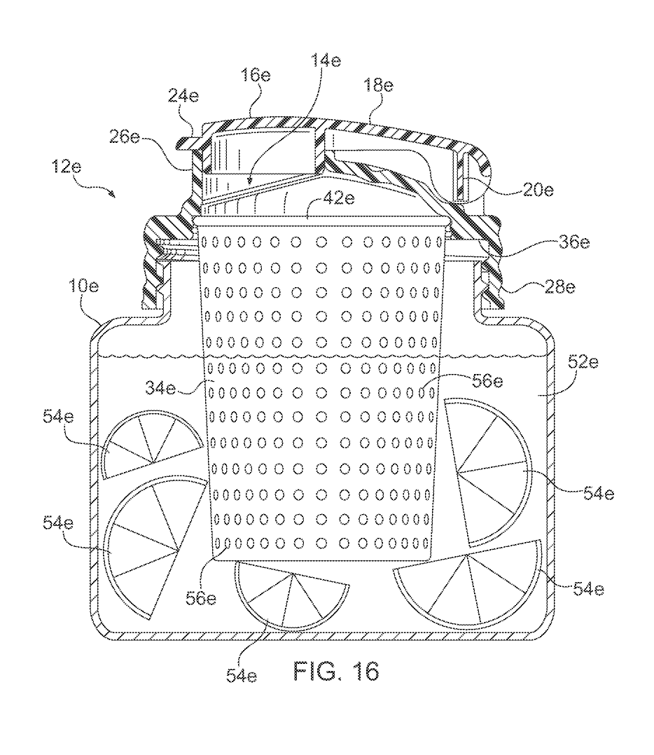

As shown in FIG. 16, the accessory 34e can be an infuser. This infuser embodiment of the accessory 34e works in conjunction with the jar 10e. The accessory 34e takes advantage of a certain amount of space within the jar 10e so that the accessory 34e can separate a volume of the liquids 52e from the rest of the contents 54e contained within the jar 10e. For example, if the jar 10e contains some variety of fruit slices 54e and some variety of tea 52e, the accessory 34e may filter the tea 52e from the fruit slices 54e and only let the tea 52e escape from the jar. This allows the fruit slices 54e and tea 52e to infuse with each other without there being any accidental loss of the fruit slices 54e from the jar 10e. A user (not shown) may then release the jar lid 12e from the jar 10e, dismount the accessory 34e from the jar lid 12e, and then remove these fruit slices 54e from the jar 10e. It should be understood the above is only one example of the implementation of this embodiment of the accessory 34e. The infuser embodiment of the accessory 34a can be used for other filtration purposes not discussed herein. It should be noted that infusion occurs when particulate matter falls off from the contents 54e and intermixes with the liquid 52e, in an attempt to change some property (such as the viscosity, flavor, etc.) of the liquid 52e.

This embodiment of the jar lid 12e includes an inner rim 36e on its underside. The infuser embodiment of the accessory 34e is releasably mounted to the inner rim 36e through the mounting instrument, which in this embodiment is the friction fitting between the accessory 34e and the inner rim 36e. A lip 42e around at least a portion of the perimeter of the accessory 34e makes contact with the inner rim 36e. Once mounted to the inner rim 36e, the friction fitting between the lip 42e and the inner rim 36e helps to keep the accessory 34e in place and from accidentally falling off the jar lid 12e. A plurality of infuser openings 56e throughout the body of the accessory 34e allow the volume of the liquid 52e to pass through the accessory 34e and into the central area (not shown) of the accessory 34e without the contents Me being able to enter into this central area. Once in the central area, the liquids 52e can be leisurely poured out through the opening 14e of the jar lid 12e.

It should be understood that, in certain instances, this embodiment of the accessory could have at least one additional accessory (not shown) releasably mounted to it. For example, the accessory 34e could have a strainer embodied additional accessory releasably mounted at the open end of the accessory 34e. This would allow the contents to be placed directly into the central area of the accessory 34e.

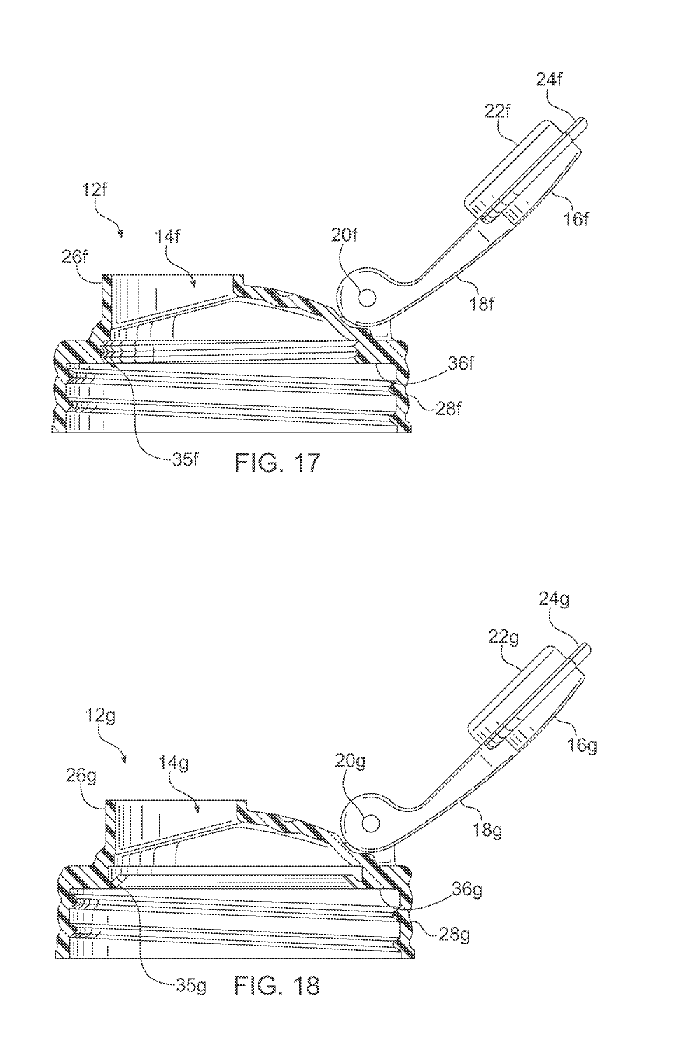

As shown in FIG. 17, the mounting instrument, which permits the accessory to be releasably mounted to the jar lid 12f, may be embodied as something other than friction fitting. The mounting instrument 35f can be threading at the inner rim 36f of the jar lid 12f. In this embodiment, the mounting instrument 35f permits the accessory to be threadably mounted to the jar lid 12f, which maintains releasability of the accessory. As shown in FIG. 18, the mounting instrument 35g can be clips at the inner rim 36g of the jar lid 12g. This embodiment of the mounting instrument 35g permits releasable mounting through gripping the accessory to the jar lid 12g. The accessory may be dismounted by being pulled apart from the jar lid 12g in a manner that properly releases the grip of the mounting instrument 35g.

The mounting instrument 35g can also be embodied as at least one tack that releasably mounts the accessory to the jar lid 12g. The tack embodiment of the mounting instrument 35g permits releasable mounting by fastening the accessory to the jar lid 12g. The mounting instrument 35g is driven through the inner rim 36g (or some other location on the jar lid 12g) and into some location on the accessory. To release the accessory, the mounting instrument 35g can be removed from the jar lid 12g. The mounting instrument 35g can also be embodied as at least one screw that releasably mounts the accessory to the jar lid 12g. The screw embodiment of the mounting instrument 35g permits releasable mounting by fastening the accessory to the jar lid 12g. The mounting instrument 35g is driven through the inner rim 36g (or some other location on the jar lid 12g) and releasably fastened into some portion of the accessory. To release the accessory, the mounting instrument 35g can be unscrewed from the jar lid 12g.

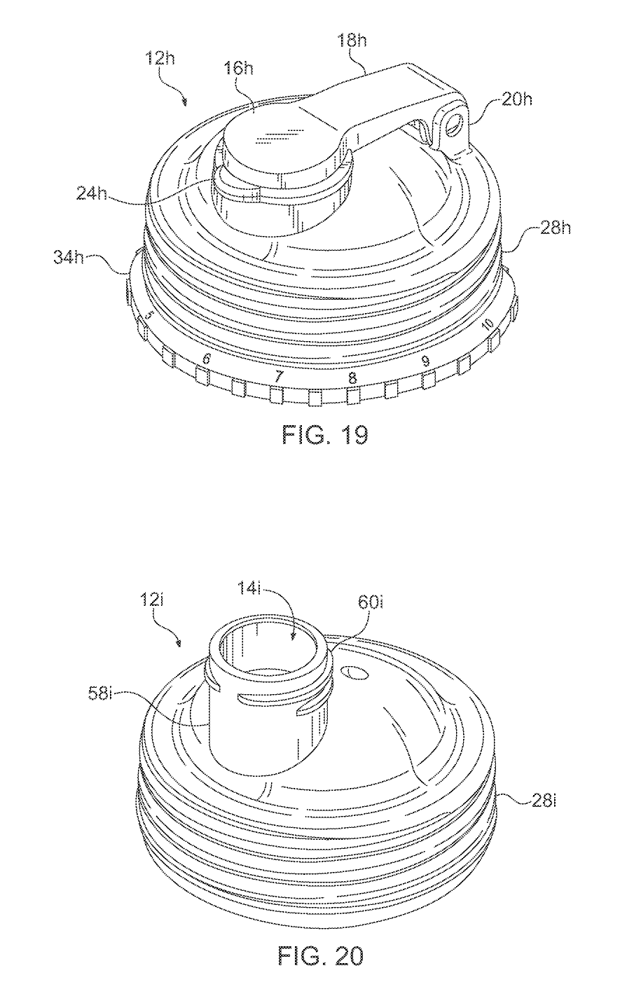

As shown in FIG. 19, the accessory 34h can be a counter ring. This counter ring embodiment of the accessory 34h allows a user to count the contents within the jar. For example, fine grains of flour, sugar, or parmesan cheese can be poured out of the jar and the accessory 34h can subsequently be adjusted to indicate the amount of these contents that remain within the jar. This counter ring embodiment of the accessory 34h can also provide dating information for the contents within the jar, which let the user understand the age of these contents. For example, if the jar and jar lid 12h remains in storage, the accessory 34h can be adjusted to indicate the date when they were put into storage. It should be understood that the counter ring embodiment of the accessory 34h can be used for other counting/dating purposes not discussed herein.

The accessory 34h is releasably mounted to the lid base 28h through the mounting instrument, which in this embodiment is the friction fitting between the accessory 34h and the lid base 28h. Once mounted to the lid base 28h, the friction fitting helps to keep the accessory 34h in place and from accidentally dismounting from the jar lid 12h. It should be understood that, in certain instances, the jar lid 12h could have at least one additional accessory (not shown) releasably mounted to it, while implementing this embodiment of the accessory 34h. For example, the accessory 34h could be releasably mounted to the lid base 28h, while a portion cup embodiment of an additional accessory is simultaneously releasably mounted to the inner rim 36h of the jar lid 12h.

As shown in FIGS. 20 and 21, another embodiment of the jar lid 12i has a semi dome-shaped body and includes an opening 14i that goes through the jar lid 12i. The opening 14i includes an extended spout 58i that facilitates pouring any contents out from within the jar, by helping to direct the contents onto the desired location (not shown). The extended spout 58i includes spout threading 60i on its outer surface so an embodiment of the plug 16i can be releasably mounted to the opening 14i through the extend spout 58i. The plug 16i, through the spout threading 60i, releasably plugs the opening 14i. As shown, the opening 14i is located closer to the lid base 28i on one side of the jar lid 12i, but the opening 14i can be centrally located on the jar lid 12i. It should be understood that an embodiment of the accessory can also be releasably mounted to the extended spout 58i through a mounting instrument, which could be the spout threading 60i, as will be discussed below. It should also be understood that the opening 14i could include cross sectional shapes that are not circular, as shown, such as, but not limited to, square, octagonal, triangular, or some other appropriate shape.

The jar lid 12i also includes a lid base 28i that allows the jar lid 12i to releasably secure to the mouth of the jar. In this embodiment, the lid base 28i is ribbed on both its outer surface and inner surface. The ribbing on the inner surface of the jar lid 12i corresponds with the threading surrounding the mouth of its respective jar, which allows the jar lid 12i to releasably secure to the jar. It should be understood that the lid base 28i could be its own independent ring-shaped component that is peripherally connectable to the jar lid 12i and not necessarily permanently connected the body of the jar lid 12i.

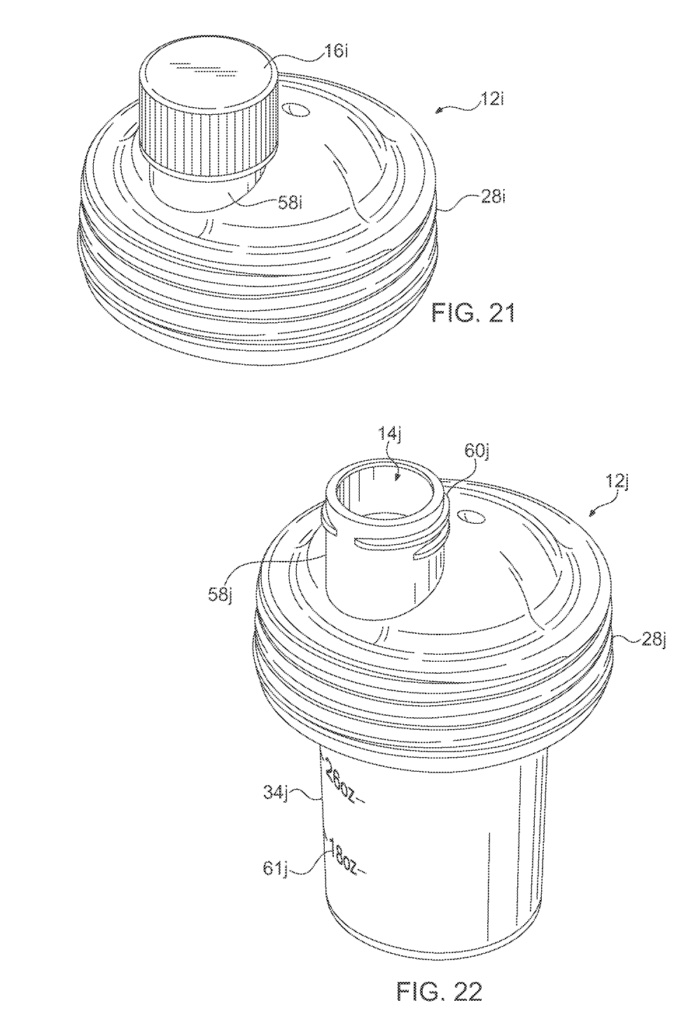

As shown in FIG. 22, the jar lid 12j, as shown as the embodiment discussed in FIGS. 20 and 21, can have an accessory 34j releasably mounted that is a liquid-proof container. This container embodiment of the accessory 34j works in conjunction with the jar. The accessory 34j takes advantage of empty space within the jar so that the accessory 34j can contain contents segregated from the contents within the rest of the jar. For example, if the jar contains some variety of liquid, the accessory 34j may contain contents that are dry, such as, granola, candy, vegetables, rice, etc. A user (not shown) is able to carry both the liquid and the contents without the liquid contaminating the contents. The user may then release the jar lid 12j from the jar, dismount the accessory 34j from the jar lid 12j, and access the contents from the accessory 34j. It should be understood that the above is only one example of the implementation of this embodiment of the accessory 34j. The container embodiment of the accessory 34j can be used for other containment/segregation purposes not discussed herein. It should also be understood that this embodiment of the accessory 34j is not limited to being releasably mounted to any particular embodiment of the jar lid 12j. The container embodiment of the accessory 34j can also incorporate container markings 61j that allow a user to measure the amount of contents that are within the accessory 34j.

This embodiment of the jar lid 12j includes an inner rim (not shown) on its underside. The accessory 34j is releasably mounted to the inner rim through the mounting instrument, which in this embodiment is the friction fitting between the accessory 34j and the inner rim. Once mounted to the inner rim, the friction fitting between the lip 42j and the inner rim helps to keep the accessory 34j in place and from accidentally falling off the jar lid 12j. It should be understood that, in certain instances, this embodiment of the accessory could have at least one additional accessory (not shown) releasably mounted to it. For example, the accessory 34j could have a strainer embodied additional accessory releasably mounted at one end.

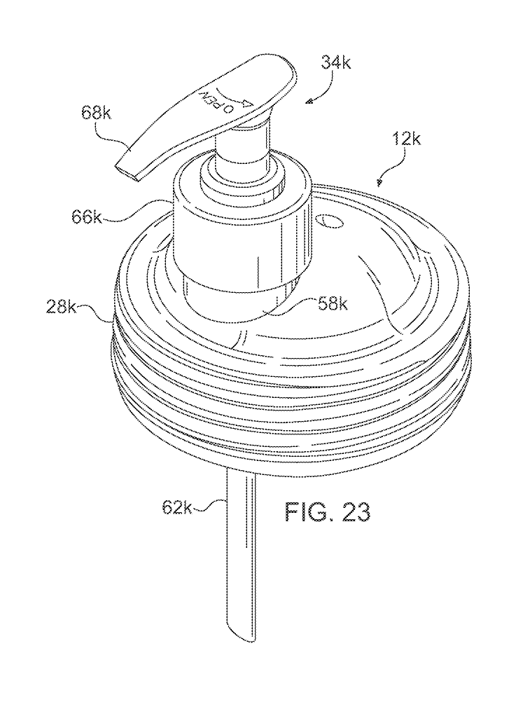

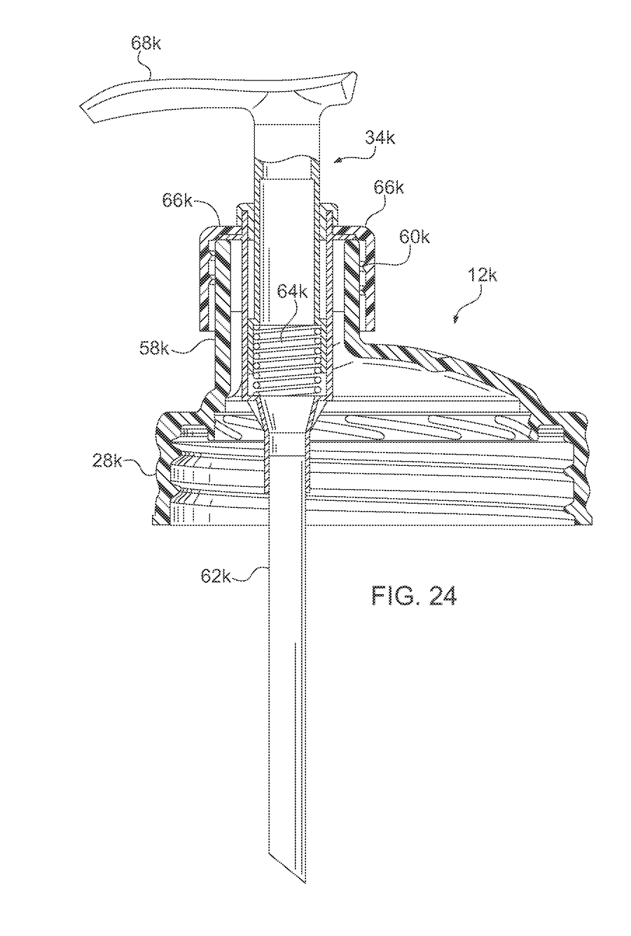

As shown in FIGS. 23 and 24, the jar lid 12k, as shown as the embodiment discussed in FIGS. 20 and 21, can have an accessory 34k releasably mounted to it that is a fluid pump. This fluid pump embodiment of the accessory 34k works in conjunction with the jar and is a non-aerosol approach to dispensing fluid materials from within the jar. For example, if the jar contains some variety of liquid, such as, but not limited to, a soap or lotion, the accessory 34k allows a user to easily distribute this liquid by receiving doses emitted from the accessory 34k. A user simply needs to press down on or squeeze the accessory 34k to distribute a dosage of the liquid. It should be understood that the above is only one example of the implementation of this embodiment of the accessory 34k. The fluid pump embodiment of the accessory 34k can be used for other distribution purposes not discussed herein. It should also be understood that this embodiment of the accessory 34k is not limited to being releasably mounted to any particular embodiment of the jar lid 12k.

The fluid pump embodiment of the accessory 34k includes a pump straw 62k, pump spring 64k, pump mount 66k and pump dispenser 68k. When pressure is applied to pump dispenser 68k, the pump spring 64k and pump straw 62k work in conjunction to create suction within the pump straw 62k that can capture any fluids in the jar. Theses captured fluids are then pushed up the pump straw 62k and through the pump dispenser 68k, to be distributed in a dosage to a user. The pump mount 66k releasably mounts the accessory 34k to the extended spout 58k through the mounting instrument, which in this embodiment is the spout threading 60k. One having ordinary skill in the art should see that, in certain instances, this embodiment of the accessory 34k may be purchased/manufactured independently and subsequently incorporated with this embodiment of the jar lid 12k.

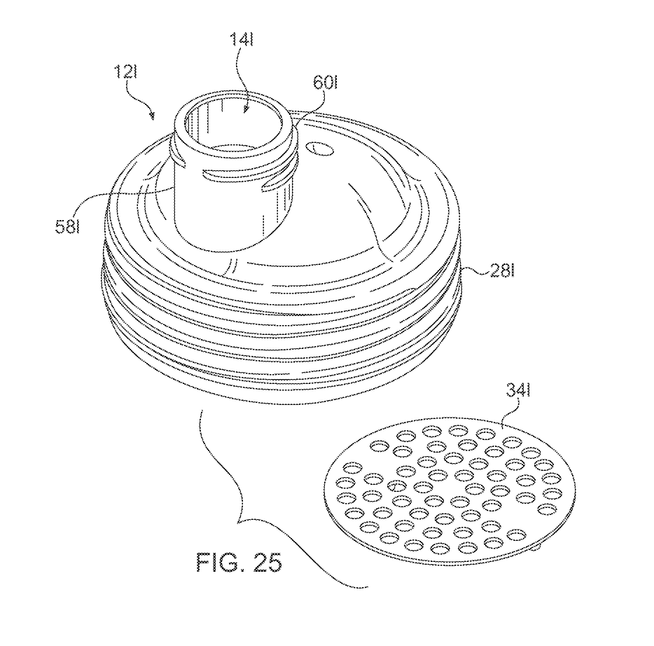

As shown in FIG. 25, the jar lid 12l, as shown as the embodiment discussed in FIGS. 20 and 21, can have an accessory 34l releasably mounted to it that is a strainer, which has been discussed in further detail above. This embodiment of the jar lid 12l includes an inner rim (not shown) on its underside. The strainer embodiment of the accessory 34l is releasably mounted to the inner rim through the mounting instrument, which in this embodiment is the friction fitting between the accessory 34l and the inner rim. Once mounted to the inner rim, the friction fitting helps to keep the accessory 34l in place and from accidentally falling off the jar lid 12l.

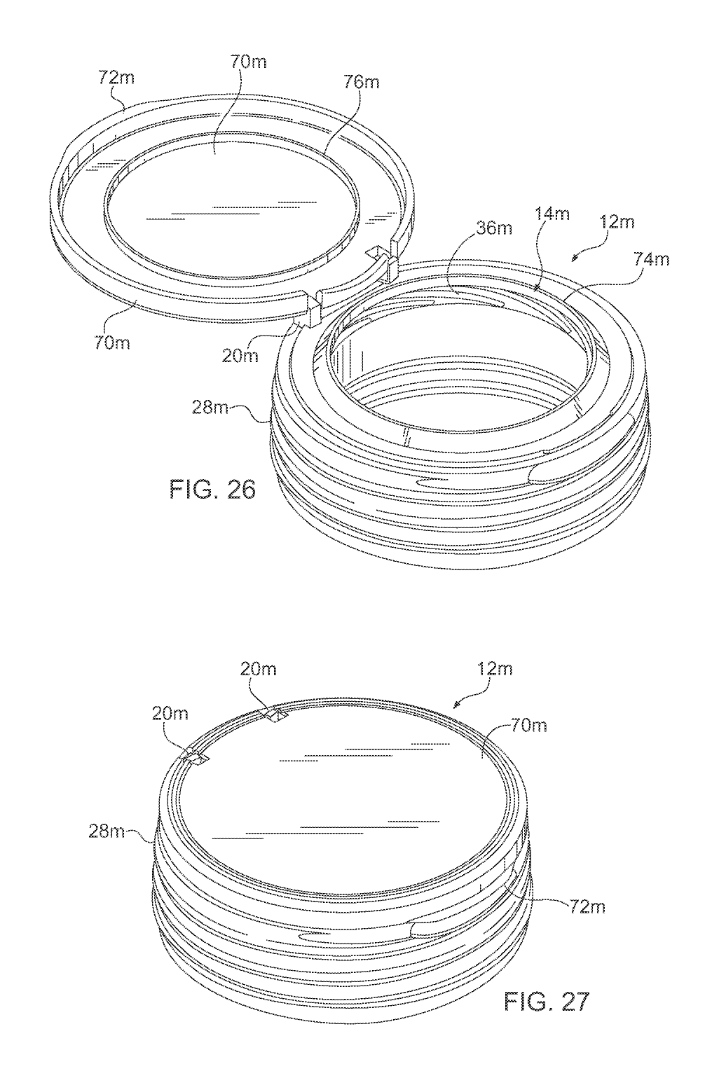

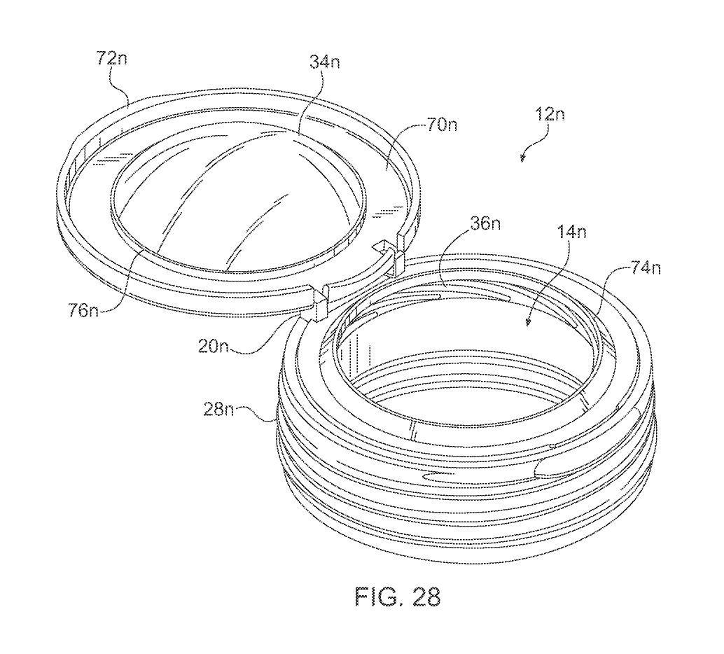

As shown in FIGS. 26 and 27, another embodiment of the jar lid 12m includes an opening 14m that is substantially as wide as the entire body of the jar lid 12m. The jar lid 12m also includes a flip-top cap 70m that is hingedly secured to the jar lid through a hinge 20m. The hinge 20m allows the flip-top cap 70m to have an angle of rotation around the jar lid 12m, which goes from the open position to the closed position of the flip-top cap 70m. The flip-top cap 70m releasably covers the entire opening and top of the jar lid 12m when in the closed position. Also when in the closed position, the flip-top cap 70m restricts the opening 14m so that any contents are much less likely to enter into or escape from within of the jar. The flip-top cap 70m includes a cap tab 72m that makes releasing the flip-top cap 70m from the opening 14m easier. In this embodiment, the opening 14m includes a raised perimeter 74m that facilitates pouring any contents out from within the jar, by helping to direct the contents onto the desired article (not shown). The flip-top cap 70m includes a cap rim 76m that, when the flip-top cap 70m is in the closed position, comes into contact with the perimeter 74m and considerably seals off the opening 14m.

This embodiment of jar lid 12m also allows a user (not shown) to scoop out the contents within jar using a utensil, such as a fork or spoon. This embodiment of the jar lid 12m can also facilitate the releasable mounting of accessories not thought to be implemented by other embodiments of the jar lid 12m and enhance the capabilities of the accessories previously discussed herein. It should be understood that the opening 14m could include cross sectional shapes that are not circular, as shown, such as, but not limited to, square, octagonal, triangular, or some other appropriate shape.

The jar lid 12m also includes a lid base 28m that allows the jar lid 12m to releasably secure to the mouth of the jar. In this embodiment, the lid base 28m is ribbed on both its outer surface and inner surface. The ribbing on the inner surface of the jar lid 12m corresponds with the threading surrounding the mouth of the respective jar, which allows the jar lid 12m to releasably secure to the jar. It should be understood that the lid base 28m could be its own independent ring-shaped component peripherally connectable to the jar lid 12m and not necessarily permanently connected the body of the jar lid 12m.

As shown in 28, the accessory 34n can be a magnifying lens. The accessory 34n takes advantage of the jar when containing contents that can be viewed in better detail through magnification, discussed above. This embodiment of the jar lid 12n includes a cap rim 76n on the flip-top cap 70n. The accessory 34n is releasably mounted to the cap rim 76n through the mounting instrument, which in this embodiment is the friction fitting between the accessory 34n and the cap rim 76n. Once mounted to the cap rim 76n, the friction fitting helps to keep the accessory 34n in place and from accidentally falling off the jar lid 12n.

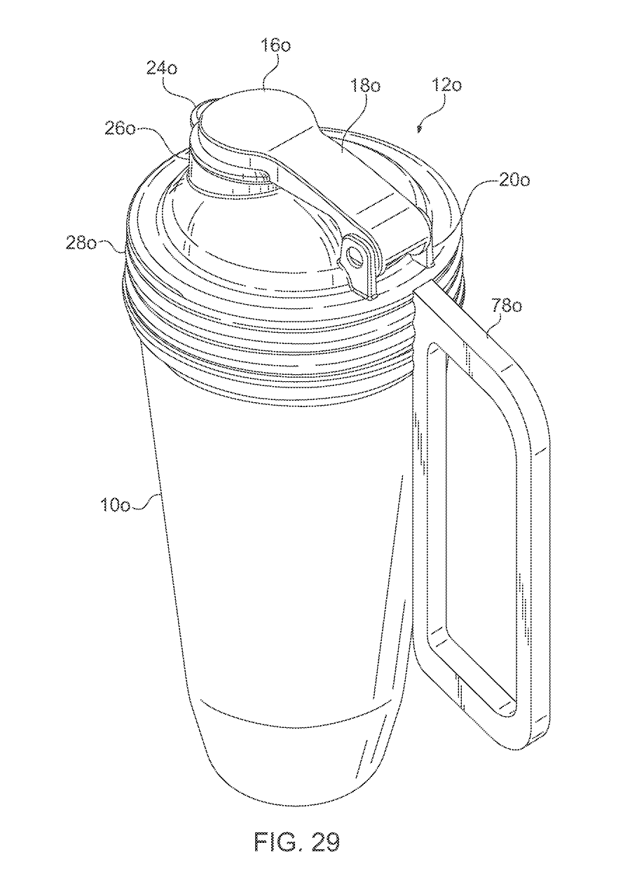

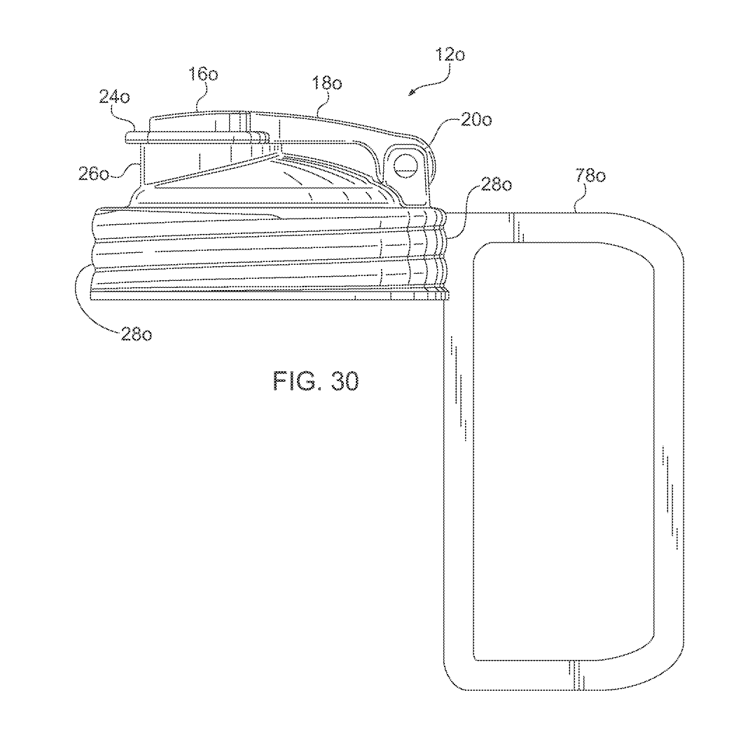

As shown in FIGS. 29 and 30, the jar lid 12o can include a handle 78o. In this embodiment, the handle 78o is laterally connected to the lid base 28o. The handle 78o is a component by which a user (not shown) can grip and carry the jar lid 12o and jar 10o, when the jar lid 12o is releasably secured to the jar 10o. The handle 78o is also ergonomically constructed to make it harder for a user to lose their grip when carrying the jar lid 12o. It should be noted that the word “include” is herein considered open ended and non-limiting.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A jar lid for releasably securing to a jar, said jar lid comprising:
an opening through said jar lid;
a lid base extending from said jar lid, said lid base for releasably securing said jar lid to the mouth of the jar; and
a mounting instrument for permitting an accessory to be releasably mountable to said jar lid.

2. The jar lid of claim 1 further comprising a plug hingedly secured to said jar lid, said plug for releasably plugging said opening.

3. The jar lid of claim 1 further comprising a flip-top cap hingedly secured to said jar lid, said flip-top cap for releasably covering said opening.

4. The jar lid of claim 1 further comprising a handle.

5. The jar lid of claim 1 further comprising a gasket secured to the underside of said jar lid, said gasket for creating a seal between said jar lid and the mouth of the jar when said jar lid is releasably secured to the mouth of the jar.

6. The jar lid of claim 1 further comprising an inner rim on the underside of said jar lid and said mounting instrument at said inner rim.

7. The jar lid of claim 1 wherein said mounting instrument is for permitting an accessory to be releasably mountable to said opening of said jar lid.

8. The jar lid of claim 1 wherein said mounting instrument is a clip, tack, screw, friction fitting, or threading.

9. The jar lid of claim 1 wherein said opening comprising a spout.

10. The jar lid of claim 1 wherein said opening comprising an extended spout with spout threading.

11. The jar lid of claim 1 wherein said lid base is connectable to said jar lid.

12. The jar lid of claim 1 wherein said lid base peripherally extending from said jar lid and said lid base comprising threading.

13. The jar lid of claim 1 wherein said accessory is a magnifying lens.

14. The jar lid of claim 1 wherein said accessory is a container.

15. The jar lid of claim 1 wherein said accessory is a fluid pourer.

16. The jar lid of claim 1 wherein said accessory is a strainer.

17. The jar lid of claim 1 wherein said accessory is a portion cup.

18. The jar lid of claim 1 wherein said accessory is a straw.

20. The jar lid of claim 1 wherein said accessory is a fluid pump.

21. The jar lid of claim 1 wherein said accessory is an infuser.

22. The jar lid of claim 1 wherein said jar lid is made from polymer plastic, metals, acrylics, wood, cloth, glass, or paper-based material.

23. A jar lid for releasably securing to a jar, said jar lid comprising:
an opening through said jar lid, said opening comprising an extended spout with spout threading;
a lid base extending from said jar lid, said lid base comprising threading for threadably securing the jar lid to the mouth of the jar;
a gasket secured to the underside of said jar lid, said gasket for creating a seal between said jar lid and the mouth of the jar when said jar lid is threadably secured to the mouth of the jar; and
a mounting instrument for permitting an accessory to be releasably mountable to said jar lid.

24. The jar lid of claim 23 further comprising a handle.

25. The jar lid of claim 23 further comprising an inner rim on the underside of said jar lid and said mounting instrument at said inner rim.

26. The jar lid of claim 23 wherein said opening is centrally located.

27. The jar lid of claim 23 wherein said mounting instrument is for permitting an accessory to be releasably mountable to said opening of said jar lid.

28. The jar lid of claim 23 wherein said mounting instrument is a clip, tack, screw, friction fitting, or threading.

29. The jar lid of claim 23 wherein said accessory is a magnifying lens, container, fluid pourer, strainer, portion cup, straw, fluid pump, counter ring, or an infuser.

30. The jar lid of claim 23 wherein said jar lid is made from polymer plastic, metals, acrylics, wood, cloth, glass, or paper-based material.

31. A jar lid for releasably securing to a jar, said jar lid comprising:
an opening through said jar lid comprising a spout;
a plug hingedly secured to said jar lid, said plug for releasably plugging said opening;
a lid base extending from said jar lid, said lid base comprising threading for threadably securing the jar lid to the mouth of the jar;
a gasket secured to the underside of said jar lid, said gasket for creating a seal between said jar lid and the mouth of the jar when said jar lid is threadably secured to the mouth of the jar; and
a mounting instrument for permitting an accessory to be releasably mountable to said jar lid.

32. The jar lid of claim 31 further comprising a handle.

33. The jar lid of claim 31 further comprising an inner rim on the underside of said jar lid and said mounting instrument at said inner rim.

34. The jar lid of claim 31 wherein said mounting instrument is for permitting an accessory to be releasably mountable to said opening of said jar lid.

35. The jar lid of claim 31 wherein said mounting instrument is a clip, tack, screw, friction fitting, or threading.

36. The jar lid of claim 31 wherein said accessory is a magnifying lens, container, fluid pourer, strainer, portion cup, straw, fluid pump, counter ring, or an infuser.

37. The jar lid of claim 31 wherein said jar lid is made from polymer plastic, metals, acrylics, wood, cloth, glass, or paper-based material.

38. A jar lid for releasably securing to a jar, said jar lid comprising:
an opening through said jar lid;
a flip-top cap hingedly secured to said jar lid, said flip-top cap for releasably covering said opening;
a lid base extending from said jar lid, said lid base comprising threading for threadably securing the jar lid to the mouth of the jar;
a gasket secured to the underside of said jar lid, said gasket for creating a seal between said jar lid and the mouth of the jar when said jar lid is threadably secured to the mouth of the jar; and
a mounting instrument for permitting an accessory to be releasably mountable to said jar lid.

39. The jar lid of claim 38 further comprising a handle.

40. The jar lid of claim 38 further comprising an inner rim on the underside of said jar lid and said mounting instrument at said inner rim.

41. The jar lid of claim 38 wherein said mounting instrument is for permitting an accessory to be releasably mountable to said opening of said jar lid.

42. The jar lid of claim 38 wherein said mounting instrument is a clip, tack, screw, friction fitting, or threading.

43. The jar lid of claim 38 wherein said accessory is a magnifying lens, container, fluid pourer, strainer, portion cup, straw, fluid pump, counter ring, or an infuser.

44. The jar lid of claim 38 wherein said jar lid is made polymer plastic, metals, acrylics, wood, cloth, glass, or paper-based material.
